(19) United States
(12) Patent Application Publication
(10) Pub. No.: US 2025/0076573 A1
(43) Pub. Date: Mar. 6, 2025

(54) HYPERSPECTRAL COMPRESSIVE IMAGING WITH INTEGRATED PHOTONICS

(71) Applicant: The Regents of the University of California, Oakland, CA (US)

(72) Inventor: Sung-Joo Ben Yoo, Davis, CA (US)

(73) Assignee: The Regents of the University of California, Oakland, CA (US)

(21) Appl. No.: 18/487,567

(22) PCT Filed: Apr. 19, 2022
(86) PCT No.: PCT/US2022/025409

§ 371 Date: Oct. 16, 2023

Related U.S. Application Data
(60) Provisional application No. 63/177,096, filed on Apr. 20, 2021.

(51) Int. Cl. G02B 6/12; G01J 3/02; G01J 3/18; G01J 3/26; G01J 3/28; H04N 23/16

(52) U.S. Cl. CPC G02B 6/12019; G01J 3/0224; G01J 3/1895; G01J 3/26; G01J 3/2803; G01J 3/2823; G02B 6/12002; H04N 23/16; G01J 2003/2826

(57) ABSTRACT

One embodiment provides a compressive hyperspectral imaging system. The compressive hyperspectral imaging system can include a coded aperture configured to spatially encode an optical signal associated with a scene, an integrated photonic device configured to disperse the spatially encoded optical signal, and an array of photo detectors configured to detect the dispersed and spatially encoded optical signal. The output of the array of photo detectors is used for reconstruction of a hyperspectral image corresponding to the scene.

### CROSS-REFERENCE TO RELATED APPLICATIONS

This application claims priority under 35 U.S.C. § 119 (c) to U.S. Provisional Application Ser. No. 63/177,096, Attorney Docket No. UC21-604-1PSP, entitled “Achieving Hyperspectral Compressive Imaging Utilizing Reconfigurable Metaphotonics and Waveguide Photonics,” by inventor Sung-Joo Ben Yoo, filed on 20 Apr. 2021, the disclosure of which is incorporated herein by reference in its entirety.

### BACKGROUND

### Field

The disclosed embodiments generally relate to hyperspectral imaging technologies. More specifically, the disclosed embodiments relate to achieving coded aperture snapshot spectral imaging (CASSI) using meta-lenses and arrayed waveguide grating routers (AWGRs).

### Related Art

Hyperspectral imaging (HSI) is a technique that analyzes a wide spectrum of light instead of just assigning primary colors (red, green, blue) to each pixel. The light striking each pixel is broken down into many different spectral bands in order to provide more information on what is imaged. HSI has applications in many fields, such as astronomy, agriculture, molecular biology, biomedical imaging, geosciences, physics, and surveillance. For example, the National Aeronautics and Space Administration (NASA) recently initiated a new mission on the Geostationary Carbon Cycle Observatory (GeoCARB) satellite to track key metrics of climate change (e.g., the concentration and mixing ratios of the various greenhouse gases) in real time. The GeoCARB mission currently relies on a heavy, bulky, and high-energy consuming instrument (e.g., Tropospheric Infrared Mapping Spectrometers) to obtain HSI data. It is desirable to develop light, compact, and low-power consuming HSI instruments.

### SUMMARY

One embodiment provides a compressive hyperspectral imaging system. The compressive hyperspectral imaging system includes a coded aperture configured to spatially encode an optical signal associated with a scene, an integrated photonic device configured to disperse the spatially encoded optical signal, and an array of photo detectors configured to detect the dispersed and spatially encoded scene. The output of the array of photo detectors is used for reconstruction of a hyperspectral image of the scene.

In a variation on this embodiment, the system includes fewer imaging pixels than in a non-compressive hyperspectral imaging system to achieve hyperspectral imaging.

In a variation on this embodiment, the integrated photonic device is further configured to provide polarization diversity, and the system includes fewer imaging pixels than in a non-compressive hyperspectral imaging system to achieve polarimetric hyperspectral imaging.

In a variation on this embodiment, the integrated photonic device includes a meta structure.

In a further variation, the meta structure includes a substrate and a number of pillars with predetermined shapes arranged into a two-dimensional (2D) array of a predetermined pattern.

In a further variation, dimensions, shapes, and spacings of the pillars are configured based on an operating spectral band of the hyperspectral imaging system.

In a further variation, the coded aperture includes an array of liquid-crystal-based spatial light modulators or an array of phase-change material (PCM)-based Fabry-Perot filters.

In a variation on this embodiment, the array of photo detectors includes an array of avalanche photo detectors (APDs).

In a variation on this embodiment, the integrated photonic device includes a plurality of arrayed waveguide grating router (AWGR) blocks, and a respective AWGR block comprises one or more stacked AWGRs.

In a further variation, the AWGRs are stacked horizontally.

In a further variation, the AWGRs are stacked vertically, and a respective input waveguide of a respective AWGR includes a vertical section, a 45° reflector, and a horizontal section.

In a further variation, the AWGR block further includes an array of micro-lenses, and a micro-lens is to couple light into a corresponding input waveguide of the AWGRs.

In a further variation, the coded aperture is integrated into the AWGRs, and each input waveguide of a respective AWGR can include a modulator.

In a further variation, the array of photo detectors is integrated into the AWGRs, and each output waveguide of a respective AWGR includes a photo detector.

One embodiment can provide an optical encoding system. The optical encoding system can include a spatial encoder configured to spatially encode an optical signal associated with a to-be-imaged scene and a dispersive element comprising a meta structure configured to disperse the spatially encoded optical signal. The meta structure comprises a substrate and a number of pillars with predetermined shapes arranged into a two-dimensional (2D) array of a predetermined pattern, thereby allowing the dispersed and spatially encoded optical signal to be detected to reconstruct a hyperspectral image corresponding to the scene.

One embodiment can provide an optical encoding system. The optical encoding system can include a spatial encoder configured to spatially encode an optical signal associated with a to-be-imaged scene and a dispersive element comprising a plurality of arrayed waveguide grating router (AWGR) blocks configured to disperse the spatially encoded optical signal. The AWGR blocks form a two-dimensional (2D) array, and a respective AWGR block comprises one or more horizontally or vertically stacked AWGRs, thereby allowing dispersed and spatially encoded optical signal to be detected to reconstruct a hyperspectral image corresponding to the scene.

### BRIEF DESCRIPTION OF THE FIGURES

FIG. 1 illustrates an exemplary architecture of a coded aperture snapshot spectral imager (CASSI), according to prior art.

FIG. 2 illustrates an exemplary CASSI apparatus based on a meta-lens, according to one embodiment.

FIG. 3 illustrates an exemplary reconfigurable coded aperture based on phase-change materials, according to one embodiment.

FIG. 4A illustrates an exemplary unit cell of the meta-lens, according to one embodiment.

FIG. 4B illustrates the top view of the unit cell, according to one embodiment.

FIG. 4C illustrates the top view of a meta-lens consisting of an assembly of unit cells, according to one embodiment.

FIG. 4D shows the phase shift as a function of the pillar size for a given height, according to one embodiment.

FIG. 5 illustrates a number of meta-lens-design parameters for a number of wavelength bands, according to one embodiment.

FIGS. 6A-6D illustrate the field intensity at the focal point for the four meta-lens designs shown in FIG. 5, according to one embodiment.

FIG. 7 illustrates an exemplary CASSI apparatus based on arrayed waveguide grating routers (AWGRs), according to one embodiment.

FIG. 8 illustrates a horizontally stacked AWGR block, according to one embodiment.

FIG. 9A illustrates the wavelength routing of an exemplary 5×5 AWGR, according to one embodiment.

FIG. 9B illustrates the wavelength-routing mapping table for the exemplary 5×5 AWGR, according to one embodiment.

FIG. 10A illustrates an exemplary AWGR with vertical input waveguides, according to one embodiment.

FIG. 10B illustrates a vertically stacked AWGR block, according to one embodiment.

FIG. 11 illustrates an imaging system that combines both the meta-lens-based CASSI and the AWGR-based CASSI, according to one embodiment.

FIG. 12 illustrates an exemplary multi-scale CASSI system, according to one embodiment.

In the figures, like reference numerals refer to the same figure elements.

### DETAILED DESCRIPTION

The following description is presented to enable any person skilled in the art to make and use the present embodiments and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown but are to be accorded the widest scope consistent with the principles and features disclosed herein.

### Overview

The disclosed embodiments provide a novel coded aperture snapshot spectral imager (CASSI) for obtaining hyperspectral images with polarization diversity using compact three-dimensional (3D) integrated photonics. The imager can include meta-lenses and optical coded apertures, where the meta-lenses achieve dispersive and polarization diversified imaging and the optical coded apertures can apply optical codes to facilitate compressive sensing and hyperspectral image recovery. The coded apertures can be reconfigurable to allow for optimization of the optical codes for specific tasks, training using image data, and reconfiguration for different tasks. The imager can further include AWGRs, which can achieve the wavelength-space manipulation necessary for hyperspectral imaging. The input waveguides of the AWGs can have built-in modulators acting as reconfigurable coded apertures. A focal plane array (FPA) comprising an array of avalanche photodiodes (APDs) can be used to detect the spectral density used for reconstruction of the hyperspectral image.

### CASSI Architecture

Compressive sensing (CS) allows sensing and recovery of spectral scenes from far fewer measurements than would be required by conventional linear scanning spectral sensors. CS relies on two principles: sparsity (which characterizes the spectral scenes of interest) and incoherence (which shapes the sensing structure). Images of the earth satisfy these two CS principles, thus leading to successful image reconstruction. Coded aperture snapshot spectral imager (CASSI) is an imaging system that effectively exploits the above CS principles. CASSI instruments use a coded aperture and one or more dispersive elements to modulate the optical field from a scene. A detector (e.g., an FPA) captures a two-dimensional, multiplexed projection of the three-dimensional data cube representing the scene. The nature of the multiplexing depends on the relative position of the coded aperture and the dispersive element(s) within the instrument. One significant advantage of CASSI is that the entire data cube can be sensed with just a few FPA measurements, and in some cases, with just a single FPA shot.

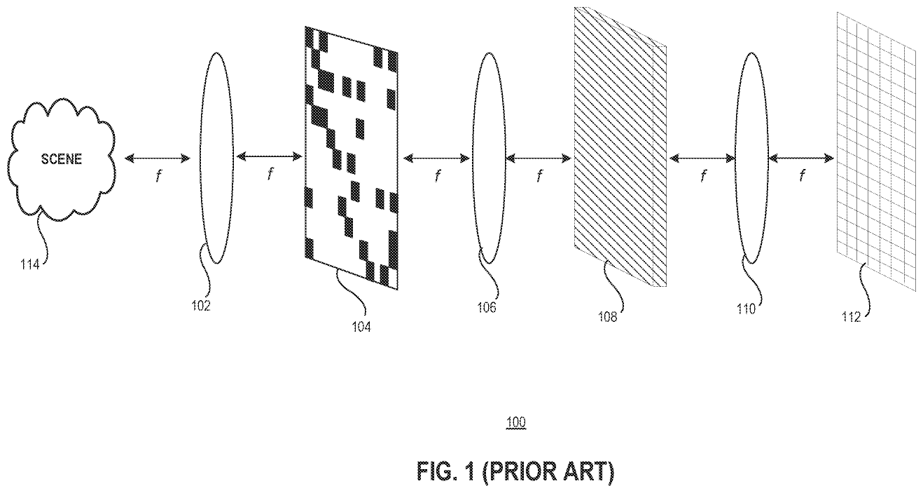

FIG. 1 illustrates an exemplary architecture of a coded aperture snapshot spectral imager (CASSI), according to prior art. CASSI 100 can include imaging optics (e.g., an objective lens) 102, a coded aperture 104, relay optics (e.g., a relay lens) 106, a dispersive element (e.g., a prism) 108, relay optics (e.g., a relay lens) 110, and a detector array (e.g., an FPA) 112. In FIG. 1, imaging optics 102 focuses a scene 114 in the plane of coded aperture 104, which modulates the spectral density of the scene spatially. The spectral density of the scene can be f₀(x, y; λ), and the transmission function of the coded aperture is denoted T(x, y). The resulting coded field f₁(x, y; λ)=f₀(x, y; λ)T(x, y) is relayed onto detector array 112 by relay optics 106, dispersive element 108, and relay optics 110. More specifically, the coded field f₁(x, y; λ) is sheared horizontally by dispersive element 108 to produce a spectral density f₂(x, y; λ), which is then optically relayed (e.g., by relay optics 110) into detector array 112, where the compressive measurements are realized by the integration over the detector's spectral range sensitivity. The detected spectral density f₂(x, y; λ) is related to the original spectral density f₀(x, y; λ) according to f₂ (x, y; λ)=f₀ (x+α(λ−λ_{c}), γ;λ)T(x+α(λ−λ_{c}),γ). Based on f₂(x, y; λ) and T(x, y), the CS algorithm can successfully recover f₀(x, y; λ).

Existing CASSI implementations rely on bulk optical components, such as bulk lenses and prisms, to achieve the spatial encoding and dispersion of the spectral components. When high spectral and spatial resolutions are needed, those bulk optical components can result in a relatively large setup. To reduce the size of the CASSI apparatus, in some embodiments, integrated photonic components, such as meta-lenses and AWGs, instead of bulk optical components, are used to achieve the goals of dispersion of spectral components and/or spatial encoding.

### Meta-Lens-Based CASSI Solution

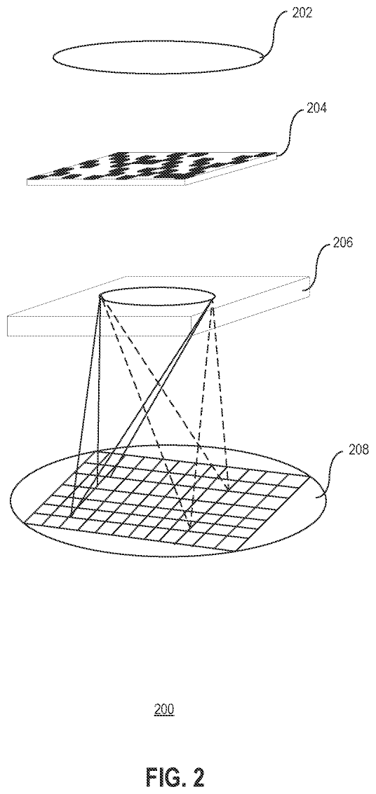

FIG. 2 illustrates an exemplary CASSI apparatus based on a meta-lens, according to one embodiment. CASSI apparatus 200 can include an objective lens 202, a coded aperture 204, a meta-lens 206, and an FPA 208. Objective lens 202 can be similar to lens 102 shown in FIG. 1 and can focus a scene onto coded aperture 204. Coded aperture 204 can spatially modulate the scene. In some embodiments, coded aperture 204 can be fixed (i.e., it can only apply one code). In one embodiment, fixed coded aperture 204 can be fabricated by depositing an opaque coating (e.g., a layer of aluminum film) on a transparent substrate (e.g., a quartz or glass substrate) and then opening apertures on the opaque coating to appropriately represent the spatial codes for compressive imaging.

In some embodiments, coded aperture 204 can be reconfigurable (i.e., it can apply different codes). In one embodiment, reconfigurable coded aperture 204 can include liquid-crystal-based spatial light modulators, which are used to form an on-off transmission filter element array. In an alternative embodiment, reconfigurable coded aperture 204 can use phase-change material (PCM) (e.g., GeSbTe (GST) and Ge₂Sb₂Sc₄Te₁ (GSST) in a Fabry-Perot filter to selectively transmit or block the spectral band of interest. For example, a layer of PCM (GST or GSST) can be placed between top and bottom distributed Bragg reflectors (DBRs) to form a phase-change-tunable filter at the desired wavelength range. Application of long or short electrical pulses to the PCM layer can change the phase of the PCM layer from amorphous to crystalline or from crystalline to amorphous, respectively, which can result in the optical refractive index changing from 6.2 to 3.5 or from 3.5 to 6.2 in the wavelength region between 1.6 and 2.6 μm while the material loss remains relatively low. In the wavelength region around 0.76 μm, the loss of the crystalline PCM may be higher. In such situations, on-off filters, instead of spectral filters, can be implemented. An exemplary reconfigurable coded aperture can include a 2D array of the Fabry-Perot (F-P) filter elements integrated with an active matrix (i.e., rows and columns) of electrical interconnections, which allows for independent reconfiguration of each Fabry-Perot filter by applying electrical pulses selectively.

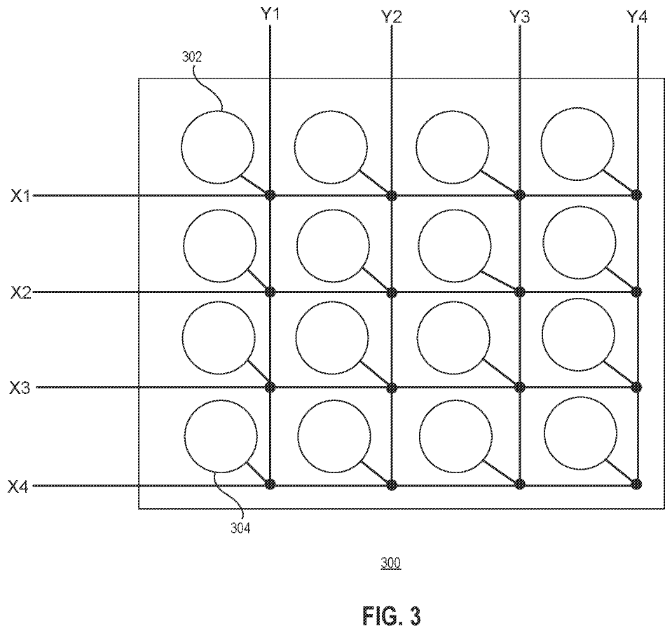

FIG. 3 illustrates an exemplary reconfigurable coded aperture based on phase-change materials, according to one embodiment. Reconfigurable coded aperture 300 can include a plurality of PCM-based F-P filters (e.g., F-P filters 302 and 304) arranged into a 2D array. Reconfigurable coded aperture 300 can also include an electrical interconnection matrix that includes multiple rows (e.g., rows X1-X4) and multiple columns (e.g., columns Y1-Y4) of signal lines. By selectively applying electrical pulses on the rows and columns of signal lines, one can selectively change the phase of the PCM layer in the F-P filters, thus configuring the coded aperture according to a desired spatial code. An exemplary process for fabricating the reconfigurable coded aperture can include depositing (e.g., using a magnetron sputtering technique) the PCM layer and the dielectric DBR films on a quartz substrate to form an F-P filter structure. The 2D array of F-P filters and the interconnection matrix can be defined using a number of subsequent processes, including lithography (e.g., projection lithograph or e-beam lithography), e-beam deposition, and liftoff.

The reconfigurable coded aperture allows for multiple-shot measurements under different codes to be obtained without the need to change the aperture. Moreover, it can allow for re-optimization of codes for different imaging purposes or missions. In some embodiments, the spatial codes implemented by the reconfigurable coded aperture can be optimized for the purposes of greenhouse gas imaging. If the imager is used for a different purpose (e.g., imaging of the Martian atmosphere), the code aperture can be reconfigured using the spatial codes optimized for that purpose.

Returning to FIG. 2, the spatially coded optical signals are sent to meta-lens 206, which shapes the wavefront of optical fields in the far field. Note that a meta-lens (also referred to as a meta structure) can be a single thin, flat structure with a number of subwavelength 3D structures (e.g., tiny pillars) arranged in specific patterns. The meta-lens shapes the wavefront of the optical fields by locally altering the phase of the incident electromagnetic (or optical) field. Compared with traditional curved lenses, meta-lenses are flat (planar) and ultra-thin and, hence, can be designed to avoid producing chromatic aberrations. Moreover, a carefully designed meta-lens can provide the desired dispersion effect, making it suitable to replace bulk dispersive element 108 shown in FIG. 1. In some embodiments, meta-lens 206 can include a SiO₂ (quartz or glass) substrate with a number of TiO₂ or Si pillars (e.g., shaped as rectangular prisms) arranged into a 2D array of a predetermined pattern.

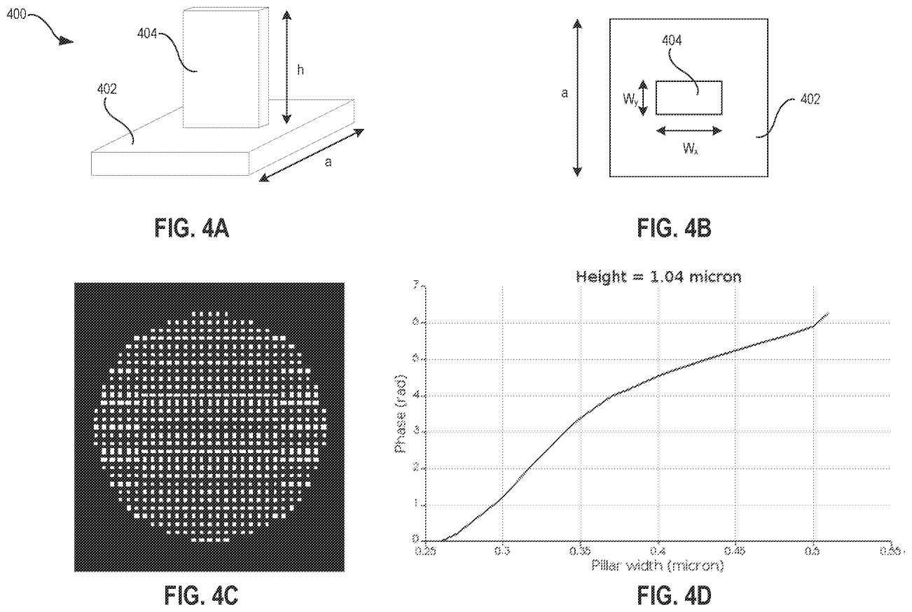

FIG. 4A illustrates an exemplary unit cell of the meta-lens, according to one embodiment. FIG. 4B illustrates the top view of the unit cell, according to one embodiment. FIG. 4C illustrates the top view of a meta-lens consisting of an assembly of the unit cells, according to one embodiment. Unit cell 400 includes a substrate portion 402 and a pillar 404. In the example shown in FIGS. 4A and 4B, substrate portion 402 can be a right square prism and the side length of its square base can be denoted a, and pillar 404 can be a rectangular prism with its height denoted h and the side lengths of its base denoted Wₓ and W_{y}. The desired dispersion effect can be achieved by selecting appropriate values for a, h, Wₓ, and W_{y}. More specifically, the shift in the relative phase due to the meta-lens elements (i.e., pillars) with respect to the center of the lens can be given by

$$φ ( x , y , λ ) = \frac{2 π}{λ} ( f - \sqrt{{x}^{2} + {y}^{2} + {f}^{2}} ) ,$$

where λ is the wavelength, f is the focal distance, and x and y indicate the position of the unit cell. FIG. 4D shows the phase shift as a function of the pillar size for a given height, according to one embodiment. One can see from FIG. 4D that the desired range of phase shift (i.e., 0-2π) has been achieved for a given wavelength (e.g., λ=1.61 μm).

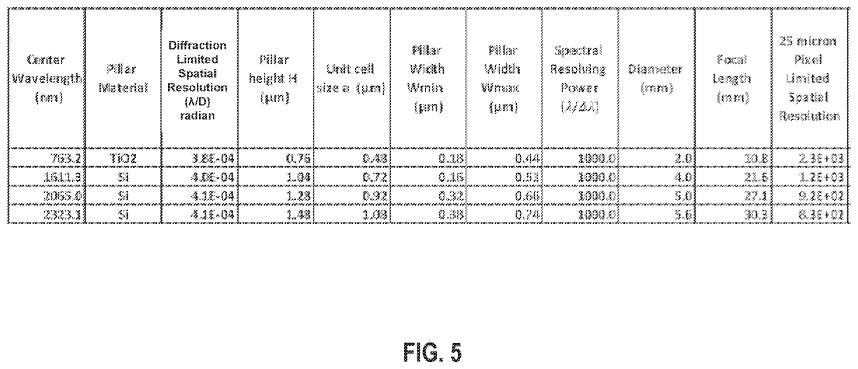

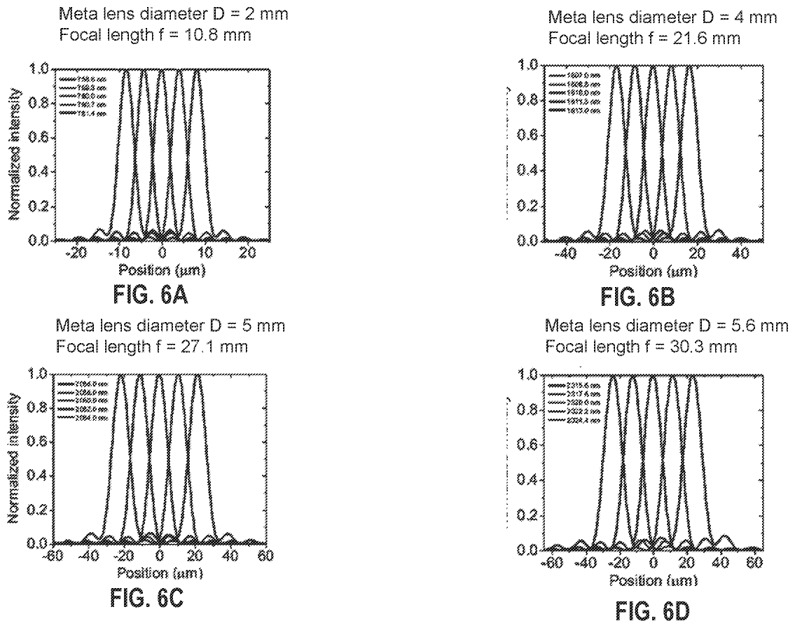

In some embodiments, the spectral resolving power of roughly 1000 (e.g., 2 nm spectral resolution at 2061 nm wavelength) can be achieved with reasonably compact meta-lenses of a diameter 2500λ. For example, the diameter of the meta-lens can be around 5 mm for a wavelength of 2061 nm and around 2 mm for a wavelength of 763 nm. A higher resolving power (e.g., around 15,000) can be achieved using a larger diameter meta-lens. FIG. 5 illustrates a number of meta-lens-design parameters for a number of wavelength bands, according to one embodiment. The different wavelengths correspond to the center wavelength of bands of interest for different gases in the atmosphere (e.g., O₂ at 763.2 nm, weak CO₂ at 1611.3 nm, strong CO₂ at 2065.0 nm, and CH₄ and CO at 2323.1 nm). In the examples shown in FIG. 5, the F-number of the lenses (i.e., the ratio of the lens focal length to the lens diameter) is roughly F/5. Note that the F-number determines the signal to noise ratio, and meta-lenses with smaller F-numbers (e.g., F/3 or F/2) are preferred so long as the corresponding meta structures can be fabricated. FIGS. 6A-6D illustrate the field intensity at the focal point for the four meta-lens designs shown in FIG. 5, according to one embodiment. Note that in each drawing the leftmost curve is for the shortest wavelength, whereas the rightmost curve is for the longest wavelength. FIGS. 6A-6D demonstrate that optical signals of different wavelengths are focused onto the focal plane at different locations.

In addition to being highly dispersive (as shown in FIGS. 6A-6D), the meta-lens can also provide polarization diversity. More specifically, the shapes of the pillars play an important role in achieving polarization diversity. Because lights of the two different polarizations (i.e., S-polarization and P-polarization) experience different phase shifts in the rectangular waveguides (pillars), they disperse in different manners such that they split in two axial directions of the rectangular waveguides. For example, the S-polarization light may disperse along the Y direction, whereas the P-polarization light may disperse along the X direction.

Returning to FIG. 2, the dispersed and polarization diversified output of meta-lens 206 is projected and focused onto FPA 208. In some embodiments, FPA 208 can include an array of avalanche photodiodes (APDs). The APDs can be integrated with read-out-integrated-circuits (ROIC). In one embodiment, the APD array can be integrated with an off-the-shelf ROIC die using a micro-transfer-printing technique and lithography/liftoff process (which deposits the electrical contacts). More specifically, during printing, the APD array can be attached to the ROIC with its detector apertures facing up.

### AWGR-Based CASSI Solution

Like the meta-lenses, an AWGR can also provide the dispersion needed for CASSI applications and additional polarization diversification. In addition to serving as the dispersive element in the CASSI, the unique waveguide structure of the AWGR can also allow for the integration of the reconfigurable coded apertures and optionally the integration of the FPA. In other words, other than objective lens 102, all other components (including coded aperture 104, relay lenses 106 and 110, prism 108, and FPA 112) in conventional CASSI 100 can be achieved using a single 3D integrated, AWGR-based device, also referred to as an AWGR-CASSI front-end.

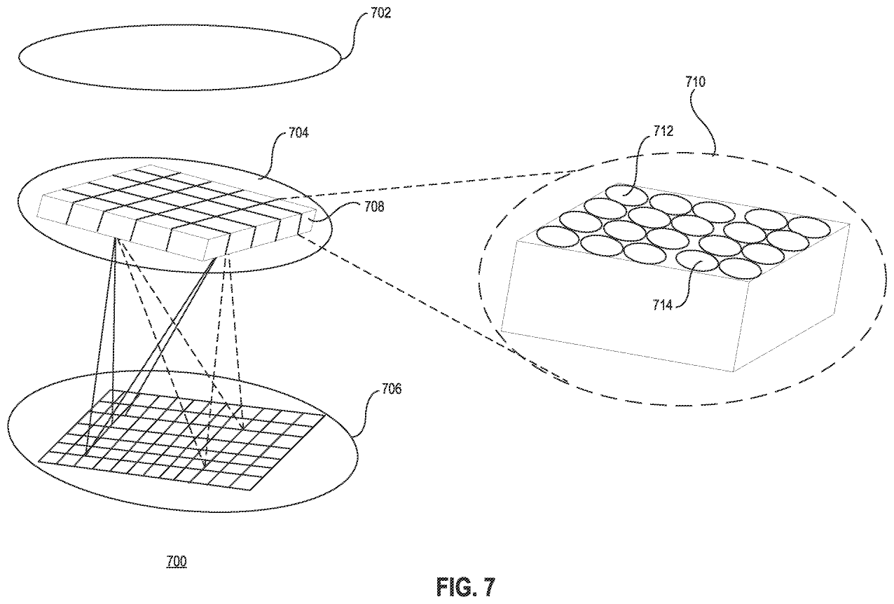

FIG. 7 illustrates an exemplary CASSI apparatus based on AWGRs, according to one embodiment. AWGR-based CASSI apparatus 700 can include a main imaging lens 702, optional micro-lens arrays, an AWGR-CASSI front-end 704, and an FPA 706. Main imaging lens 702 can be similar to lens 102 shown in FIG. 1 and can focus optical signals from a 3D scene (optionally via the micro-lens arrays) onto the input waveguides of AWGR-CASSI front-end 704. Unlike the apparatus shown in FIG. 1 or FIG. 2, AWGR-based CASSI apparatus 700 does not include a standalone bulk coded aperture. Instead, the reconfigurable coded aperture can be integrated into AWGR-CASSI front-end 704. More specifically, the reconfigurable coded aperture can be realized by including a modulator (e.g., a Mach-Zehnder switch) in each input waveguide of the AWGRs.

AWGR-CASSI front-end 704 can include an array (e.g., a 5×5 array) of 3D-stacked AWGR blocks, such as 3D-stacked AWGR block 708. FIG. 7 also shows the amplified view of 3D-stacked AWGR block 708 in dashed circle 710. More specifically, the amplified view of 3D-stacked AWGR block 708 shows a micro-lens array, which includes a number of micro-lenses such as micro-lenses 712 and 714 and can be positioned between main imaging lens 702 and the AWGRs in 3D-stacked AWGR block 708. More specifically, each micron-lens can focus light from main imaging lens 702 onto the entrance of each input waveguide within 3D-stacked AWGR block 708.

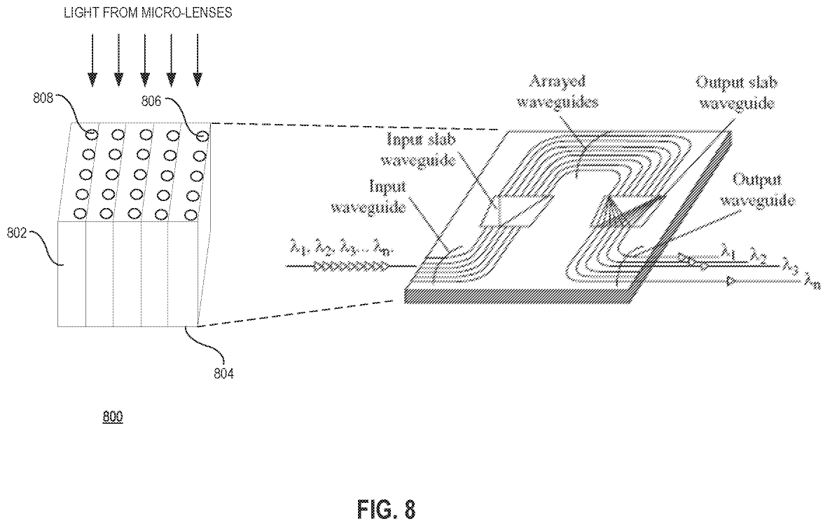

In some embodiments, each AWGR block can include multiple AWGRs stacked horizontally such that the input waveguides of the AWGRs form a vertical array to allow the micro-lens array to couple light into each individual input waveguide. Note that throughout this disclosure we use the term “vertical” to describe the orientation of the optical axis of the imaging system (i.e., the direction the light entering the AWGR blocks). Accordingly, the AWGR blocks (e.g., block 708) form a 2D array in the horizontal plane. The AWGRs in each block can be stacked horizontally or vertically. FIG. 8 illustrates a horizontally stacked AWGR block, according to one embodiment. Horizontally stacked AWGR block 800 can include a number of AWGR wafers (e.g., AWGR wafers 802 and 804) placed adjacent to each other sideways such that the input waveguides of each AWGR (e.g., input waveguides 806 and 808) can form a vertical array to receive light from the micro-lenses. FIG. 8 also illustrates the exemplary structure of each AWGR, which can include multiple input waveguides, an input slab waveguide, arrayed waveguides, an output slab waveguide, and multiple output waveguides. Note that, because the AWGR may have a different wavelength routing order for TE and TM polarizations, in addition to being highly dispersive, the AWGR can also enable polarization diversifying. FIG. 8 shows that the micro-lenses and AWGRs are separate devices. Alternatively, the micro-lenses can be integrated into the AWGRs (e.g., each input waveguide of the AWGRs can include an integrated micro-lens).

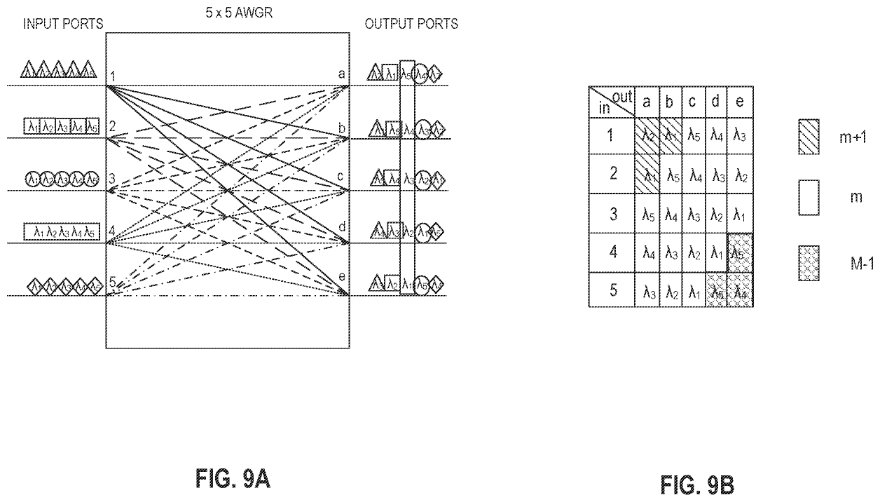

FIG. 9A illustrates the wavelength routing of an exemplary 5×5 AWGR, according to one embodiment. FIG. 9A shows that, for each input port/waveguide, the output ports/waveguides can function as a wavelength demultiplexer. Light input to the multiple input waveguides will demultiplex to the same set of output waveguides but in a perfect-shuffle wavelength-routing mapping, so that compressive imaging is possible. FIG. 9B illustrates the wavelength-routing mapping table for the exemplary 5×5 AWGR, according to one embodiment. More specifically, FIG. 9B shows the wavelength routing map for the TE polarization mode for spectral band λ₁-λ₅. FIG. 9B also illustrates that the different output wavelengths belong to different grating orders (e.g., m, m+1, and m−1). Note that for the TM polarization mode, the AWGR can be designed so that the output wavelength will be shifted by 1-10 channel spacings compared with the TE polarization mode.

In the example shown in FIG. 8, the AWGR wafers are stacked sideways, thus resulting in the AWGR block being relatively bulky. In practice, it is also possible to have the AWGR stacked on top of one another (e.g., on different layers of the same wafer) or arranged in the same plane by incorporating 45° input aperture waveguides at the input of each AWGR. More specifically, each input waveguide can include a vertical section for receiving light (e.g., from the imaging lens or the micro-lens) and a horizontal section for transmitting the light to the slab waveguide region of the AWGR. A 45° reflector at the joint between the vertical section and the horizontal section can ensure efficient light coupling between the vertical and horizontal sections.

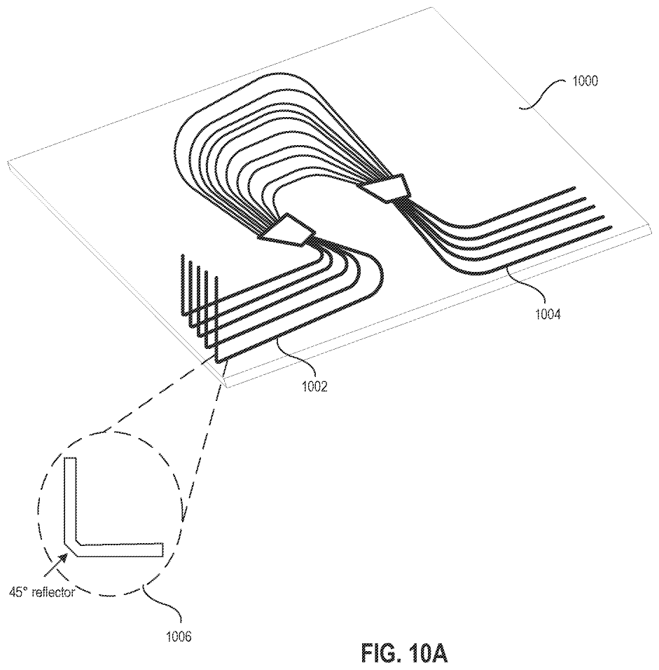

FIG. 10A illustrates an exemplary AWGR with vertical input waveguides, according to one embodiment. AWGR 1000 can include a number of input waveguides (e.g., input waveguide 1002) and a number of output waveguides (e.g., output waveguide 1004). FIG. 10A also includes, in a dashed circle 1006, an amplified front view of input waveguide 1002, showing the 45° reflector at the joint between the vertical and horizontal sections of input waveguide 1002. Note that FIG. 10A is for illustration purposes only. The number of input and output waveguides and the number and shapes of the arrayed waveguides included in an AWGR can be different from those shown in FIG. 10A. In some embodiments, to provide a high spectra resolution, AWGR 1000 can be a 512×512 AWGR with a spectral resolution of 25 GHZ. In one embodiment, AWGR 1000 can be a 512×512 AWGR with a channel spacing of 10 GHZ and a 3 dB bandwidth of 5.7 GHZ. The AWGR can be fabricated using silicon photonic technologies (e.g., using Si₃N₄ and SiO₂ as the waveguide's core and cladding layers, respectively).

To realize the reconfigurable coded aperture, each input waveguide of AWGR 1000 can be integrated with a modulator (e.g., a Mach-Zehnder switch, not shown in FIG. 10A) that can be turned on or off by electrical signals to allow or block the entrance of light to the AWGR from the input waveguide. A matrix of electrical interconnections similar to the one shown in FIG. 3 can be used to control the modulators in order to reconfigure the coded aperture. More specifically, the on-off states of the modulators can be configured based on the predetermined spatial code. In addition to the Mach-Zehnder switch, other types of electro-optic modulators can also be integrated into the waveguide structure to achieve the reconfigurable coded aperture.

FIG. 10A only shows the vertical sections of the input waveguides. In practice, the output waveguides may also have vertical sections and 45° reflectors to allow the dispersed light to exit the AWGR vertically to be coupled to the FPA (e.g., FPA 706 shown FIG. 7). In alternative embodiments, each output waveguide can include an integrated detector (e.g., an APD) to detect the light intensity, and the detection result can be sent to the image reconstruction module for reconstructing the image. In such a situation, the FPA is essentially integrated into the AWGR blocks and a standalone FPA is no longer necessary.

FIG. 10B illustrates a vertically stacked AWGR block, according to one embodiment. More specifically, vertically stacked AWGR block 1010 can include multiple layers of AWGRs vertically stacked on top of each other, such as AWGRs 1012 and 1014. Each AWGR can be similar to the one shown in FIG. 10A. To enable vertical stacking, the AWGRs can be fabricated on a multilayer silicon nitride (Si₃N₄) platform to effectively use the real estate of the wafer. To further reduce the footprint of the AWGR block, reflective AWGRs can be used. In the example shown in FIG. 10B, there are four layers of AWGR in the block. In practice, the number of layers can be more or fewer. In one embodiment, instead of being stacked, the multiple AWGRs can be coplanar, with the vertical sections of their input waveguides forming a 2D array corresponding to the micro-lens array.

Returning to FIG. 7, the size of the micro-lens (e.g., micro-lenses 712 and 714) can be adjusted to fill the footprint of each AWGR block, which will approximately equal J×K×P×P, with J being the number of AWGR layers, K being the number of input waveguides, and P being the pitch of the waveguides. Assuming P=20 μm, J=5, and K=512, the footprint of the AWGR block can be about 1.04 mm². Compared with the meta-lens-based CASSI that provides high spatial resolution, the AWGR-based CASSI can provide high spectral resolving power.

### Combined Imager

As discussed previously, the meta-lens-based CASSI can provide high spatial resolution, whereas the AWGR-based CASSI can provide high spectral resolving power. To obtain an imaging system with both high spatial and high spectral resolutions, in some embodiments, a meta-lens-based CASSI can be combined with one or more AWGR-based CASSI.

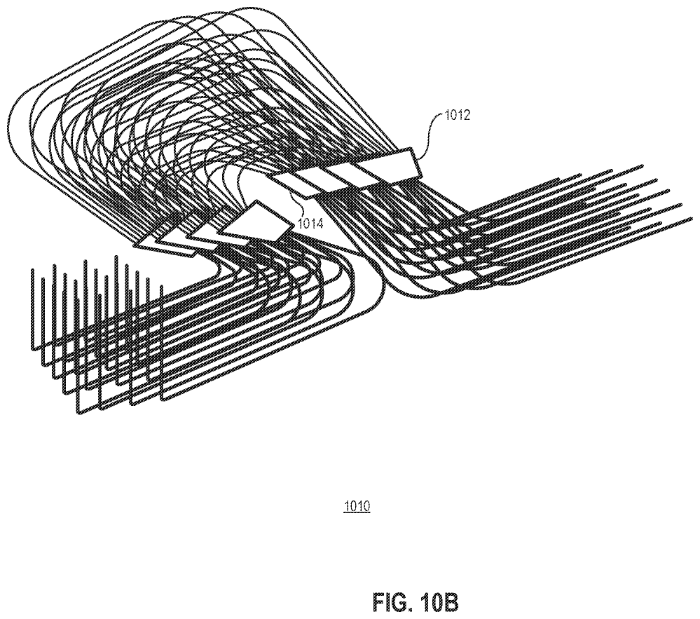

FIG. 11 illustrates an imaging system that combines both the meta-lens-based CASSI and the AWGR-based CASSI, according to one embodiment. In FIG. 11, a combined imaging system 1100 includes multiple meta-lens-based CASSI modules (e.g., CASSI modules 1102 and 1004) and multiple AWGR-based CASSI modules (e.g., CASSI modules 1106 and 1008). Note that the size of an AWGR-based CASSI module can be much smaller than a meta-lens-based CASSI module. The different meta-lens-based CASSI modules can be configured to capture images in different spectral bands; the different AWGR-based CASSI modules can also be similarly configured to capture images in different spectral bands.

In the example shown in FIG. 11, combined imaging system 1100 can be used to perform simultaneous spectral-spatial compressive measurements of four different spectral bands corresponding to the different gases of the atmosphere. For example, meta-lens-based CASSI module 1102 can be configured to capture images in the 763 nm band, and meta-lens-based CASSI module 1104 can be configured to capture images in the 1611 nm band. The other two meta-lens-based CASSI modules can be configured to capture images in the 2065 nm and 2323 nm bands. Similarly, AWGR-based CASSI modules 1106 and 1008 can be configured to capture images in the 763 nm band and the 1611 nm band, respectively, and the other two AWGR-based CASSI modules can be configured to capture images in the 2065 nm and 2323 nm bands.

By simultaneously using a meta-lens-based CASSI and an AWGR-based CASSI to obtain spectral-spatial compressive measurements of the same spectral band, combined imaging system 1100 can obtain images with both high spatial resolution and high spectral resolution. Moreover, the meta-lens-based CASSI modules and the AWGR-based CASSI modules can operate independently (e.g., by running independent compressive sensing (CS) imaging) and can perform image reconstruction in a collaborative manner such that any artifact generated during image reconstruction can be removed.

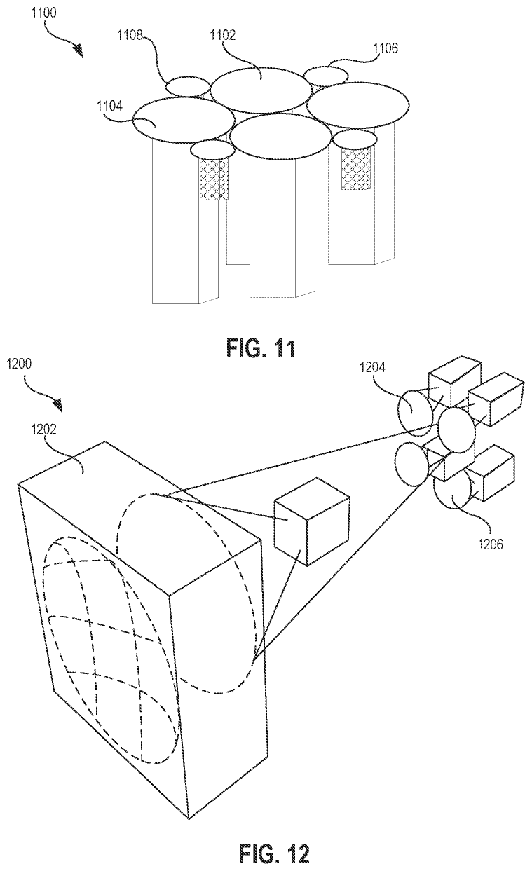

In addition to diversifying the spectral-spatial measurements using multiple CASSI modules, in some embodiments, a combined imaging system can implement multi-scale optical design to achieve a spatial resolution of megapixels and beyond. FIG. 12 illustrates an exemplary multi-scale CASSI system, according to one embodiment. Multi-scale CASSI system 1200 includes a large CASSI module 1202 and a plurality of smaller CASSI modules (e.g., CASSI modules 1204 and 1206). According to the principle of multi-scale lens design, large CASSI module 1202 can be a single aperture system on a scale matched to the target angular resolution, and the multiple smaller CASSI modules can have smaller apertures. In the example shown in FIG. 12, the four smaller scale CASSI modules placed behind larger CASSI module 1202 can be used to construct a 4× higher resolution imaging, effectively combining the four smaller CASSIs into one. In this example, the CASSI modules are based on meta-lenses. In alternative embodiments, the CASSI modules can be based on AWGRs. For example, the different layers of AWGRs in the same AWGR block can form a multi-scale lens system, with the top-layer AWGR having a larger aperture and the other layers of the AWGRs having smaller apertures. In addition, it is also possible for the multiple layers of AWGRs to achieve spectral scaling. For example, the top-layer AWGR may have a coarse channel spacing/spectral resolution, and the output of the top-layer AWGR can be sent to lower-layer AWGRs, which may have a finer channel spacing. The cascaded arrangement of the AWGRs can enhance the spectral resolution of the CASSI system.

Various compressive sensing (CS) algorithms can be used to reconstruct the hyperspectral images based on the measurement. In some embodiments, a CS imaging algorithm based on the limited-memory Broyden-Fletcher-Goldfarb-Shanno (L-BFGS) algorithm can be used to reconstruct the images. More specifically, the L-BFGS algorithm can use a nonlinear optimization solver based on quasi-Newton methods. The actual algorithm used for image reconstruction is beyond the scope of this application and will not be discussed in detail here. In some embodiments, machine-learning techniques can also be used to during the image reconstruction process to further enhance the quality of the reconstructed images. Compared with the classical non-compressive hyperspectral imaging technique that requires a large number of pixels (e.g., a spectral data cube can have a dimension of N×N×L, with N×N being the spatial pixels and L being the number of spectral bands), the CASSI system can significantly reduce the number of imaging pixels needed to achieve hyperspectral imaging. In CASSI, the N×N×L dimensions of the spectral data cube are mapped to an array of V×N FPA measurements, where V=N+L−1, benefitting from the dispersion offered by the dispersive element (e.g., the meta-lens or AWGR blocks). The coded aperture allows for a limited sampling of the spatial pixels. For example, certain CS algorithm can be used to reconstruct an image using only 10% of the original imaging pixels. In a further example, approximately 50% the coded aperture can be transparent, and a limited number of diversified measurements (including both the spectral diversity and polarization diversity) can be performed to allow for successful reconstruction of the hyperspectral images.

In general, the disclosed embodiments provide a novel CASSI system that can provide high spatial and/or high spectral resolution. Instead of using bulk optics, the novel CASSI system can use compact 3D photonics devices, including meta-lenses and AWGRs, to act as the dispersive element required by the CASSI. In addition, the AWGRs can also function as a reconfigurable coded aperture by integrating, in each input waveguide, a modulator. The spatial code can be applied by controlling those modulators. On the other hand, the meta-lens-based CASSI can include a separate reconfigurable coded aperture (e.g., an array of PCM-based F-P filters). In addition to being highly dispersive, both the meta-lens and the AWGR can provide polarization diversity. The CASSI system can use staircase APDs in the FPA to achieve high gain with nearly zero dark noise operating at 200° K. The meta-lens-based CASSI can provide high spatial resolution, and the AWGR-based CASSI can provide high spectral resolution. A combined CASSI system that includes both meta-lens-based CASSI modules and AWGR-based CASSI modules can achieve high spatial resolution and high spectral resolution at the same time. Spatial and spectral scaling can also be achieved using multi-scale lens design.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A compressive hyperspectral imaging system, comprising:
a coded aperture configured to spatially encode an optical signal associated with a scene;
an integrated photonic device configured to disperse the spatially encoded optical signal; and
an array of photo detectors configured to detect the dispersed and spatially encoded optical signal, wherein an output of the array of photo detectors is used for reconstruction of a hyperspectral image corresponding to the scene.

2. The compressive hyperspectral imaging system of claim 1, wherein the system includes fewer imaging pixels than in a non-compressive hyperspectral imaging system to achieve hyperspectral imaging.

3. The compressive hyperspectral imaging system of claim 1, wherein the integrated photonic device is further configured to provide polarization diversity, and wherein the system includes fewer imaging pixels than in a non-compressive hyperspectral imaging system to achieve polarimetric hyperspectral imaging.

4. The compressive hyperspectral imaging system of claim 1, wherein the integrated photonic device comprises a meta structure.

5. The compressive hyperspectral imaging system of claim 4, wherein the meta structure comprises a substrate and a number of pillars with predetermined shapes arranged into a two-dimensional (2D) array of a predetermined pattern.

6. The compressive hyperspectral imaging system of claim 5, wherein dimensions, shapes, and spacings of the pillars are configured based on an operating spectral band of the compressive hyperspectral imaging system.

7. The compressive hyperspectral imaging system of claim 4, wherein the coded aperture comprises one of:
an array of liquid-crystal-based spatial light modulators; and
an array of phase-change material (PCM)-based Fabry-Perot filters.

8. The compressive hyperspectral imaging system of claim 1, wherein the array of photo detectors comprises an array of avalanche photo detectors (APDs).

9. The compressive hyperspectral imaging system of claim 1, wherein the integrated photonic device comprises a plurality of arrayed waveguide grating router (AWGR) blocks, and wherein a respective AWGR block comprises one or more stacked AWGRs.

10. The compressive hyperspectral imaging system of claim 9, wherein the AWGRs are stacked horizontally.

11. The compressive hyperspectral imaging system of claim 9, wherein the AWGRs are stacked vertically, and wherein a respective input waveguide of a respective AWGR comprises a vertical section, a 45° reflector, and a horizontal section.

12. The compressive hyperspectral imaging system of claim 9, wherein the AWGR block further comprises an array of micro-lenses, and wherein a micro-lens is to couple light into a corresponding input waveguide of the AWGRs.

13. The compressive hyperspectral imaging system of claim 9, wherein the coded aperture is integrated into the AWGRs, and wherein each input waveguide of a respective AWGR comprises a modulator.

14. The compressive hyperspectral imaging system of claim 9, wherein the array of photo detectors is integrated into the AWGRs, and wherein each output waveguide of a respective AWGR comprises a photo detector.

15. An optical encoding system, comprising:
a spatial encoder configured to spatially encode an optical signal associated with a to-be-imaged scene; and
a dispersive element comprising a meta structure configured to disperse the spatially encoded optical signal, wherein the meta structure comprises a substrate and a number of pillars with predetermined shapes arranged into a two-dimensional (2D) array of a predetermined pattern, thereby allowing the dispersed and spatially encoded optical signal to be detected to reconstruct a hyperspectral image corresponding to the scene.

16. The optical encoding system of claim 15, wherein dimensions, shapes, and spacings of the pillars are configured based on an operating spectral band of the optical encoder.

17. The optical encoding system of claim 15, wherein the spatial encoder comprises one of:
an array of liquid-crystal-based spatial light modulators; and
an array of phase-change material (PCM)-based Fabry-Perot filters.

18. An optical encoding system, comprising:
a spatial encoder configured to spatially encode an optical signal associated with a to-be-imaged scene; and
a dispersive element comprising a plurality of arrayed waveguide grating router (AWGR) blocks configured to disperse the spatially encoded optical signal, wherein the AWGR blocks form a two-dimensional (2D) array, and wherein a respective AWGR block comprises one or more horizontally or vertically stacked AWGRs, thereby allowing the dispersed and spatially encoded optical signal to be detected to reconstruct a hyperspectral image corresponding to the scene.

19. The optical encoding system of claim 18, wherein the AWGRs are stacked vertically, and wherein a respective input waveguide of a respective AWGR comprises a vertical section, a 45° reflector, and a horizontal section.

20. The optical encoding system of claim 18, wherein the AWGR block further comprises an array of micro-lenses, and wherein a respective micro-lens is to couple light into a corresponding input waveguide of the AWGRs.

21. The optical encoding system of claim 18, wherein the spatial encoder is integrated with the AWGR blocks, wherein each input waveguide of a respective AWGR comprises a modulator.

22. The optical encoding system of claim 18, further comprising an array of integrated photo detectors, wherein each output waveguide of a respective AWGR comprises a photo detector.
